(19) United States
(12) Patent Application Publication
(10) Pub. No.: US 2018/0262094 A1
(43) Pub. Date: Sep. 13, 2018

(54) MAGNETICALLY COUPLED FAN ASSEMBLY AND ELECTRIC ROTARY MOTOR COMBINATION

(71) Applicant: PEOPLEFLO MANUFACTURING, INC., Franklin Park, IL (US)

(72) Inventor: William R. Blankemeier, Oak Park, IL (US)

(73) Assignee: PEOPLEFLO MANUFACTURING, INC., Franklin Park, IL (US)

(21) Appl. No.: 15/451,835

(22) Filed: Mar. 7, 2017

(51) Int. Cl. H02K 49/10; F04D 19/00; F04D 25/06; F04D 29/52; H02K 9/06; H02K 7/14; H02K 5/10

(52) U.S. Cl. CPC H02K 49/104; F04D 19/002; F04D 25/0693; H02K 5/10; F04D 29/522; H02K 9/06; H02K 7/14; F04D 25/0606

(57) ABSTRACT

A magnetically coupled fan assembly in combination with an electric rotary motor is provided. The electric rotary motor includes a housing, an inner chamber and a shaft with the shaft having a primary driving end and a secondary end. The fan assembly includes a drive hub assembly, a driven hub assembly and a canister. The drive hub assembly includes a plurality of magnets and is connected to the secondary end of the shaft. The driven hub assembly includes a plurality of magnets and a plurality of fan blades. The canister is sealingly connected to the motor housing and has a portion positioned in a gap between the magnets of the drive hub assembly and the magnets of the driven hub assembly. The canister separates the drive hub assembly and the motor inner chamber from the fan blades, and rotation of the shaft causes rotation of the fan blades.

### BACKGROUND

### Field of the Invention

The present invention generally relates to fans, especially fans used to cool electric rotary motors that have a primary purpose other than driving the cooling fan.

### Description of the Related Art

Electric rotary motors generate a considerable amount of heat when operating. Motor designs commonly utilize an external fan to assist in transferring this heat from the motor's exterior surfaces to the surrounding air. This fan is often attached to and driven by the motor's shaft on the end not being used for the primary driving function provided by the motor. The unused end of the shaft opposite the primary driving end and at the rear of the motor may otherwise be referred to as the secondary end of the shaft. Such fans are low cost and generally are very effective at cooling the motor.

Some motor designs do not use a fan, but rather rely on natural convection to transfer the heat from the motor's exterior surfaces to the surrounding air. But this method is much less effective than using a fan, so motors not cooled by a fan generally operate at a much higher temperature. As a result, such motors usually need special, more expensive internal components designed to handle the higher operating temperatures. Further, the natural convection cooling method usually is too ineffective for higher power motors.

One common use for electric rotary motors is to drive pumps. When the fluid being pumped is very hazardous, it is common to use sealless pump-motor designs. The sealless designs have no dynamic fluid seals, to minimize the chances of any leakage of the hazardous fluid. Such pumps are magnetically coupled and have a thin, stationary liner or canister through which the drive torque is transmitted, and this liner or canister is a part of the primary fluid containment barrier.

Additionally, often it is desirable to incorporate a secondary containment feature into such a pump-motor unit, so if there is a failure of the thin primary containment liner or canister, there is a secondary stationary containment barrier that will prevent the fluid from escaping the pump-motor. In the event of a failure of the primary containment liner or canister, it is normally expected that the pump operator will quickly turn off the pump. The motor is not expected to remain functional when experiencing such a failure, but the secondary containment is expected to be able to contain leakage for several days at a pressure up to the maximum rated pump pressure.

One sealless pump-motor design that includes secondary containment is commonly referred to as a canned motor pump. In a canned motor pump, the pump and motor are combined into one hermetically sealed unit. The motor stator has a thin, stationary liner on its inner surface that serves as a part of the primary fluid containment barrier, and the drive torque is transmitted through this liner to the motor rotor. Pumped fluid normally circulates through the motor and is contained within the pump and stator lining. Secondary fluid containment is provided by the motor's casing, such that if the primary containment liner fails, the pumped fluid will be contained by the motor's casing. In the event of primary containment liner failure, the pumped fluid will contact the stator and may damage it, but this normally is considered acceptable in light of the value of secondary containment.

While the typical canned motor pump design provides reliable secondary containment, it has a disadvantage in that it requires complex and expensive motor features, because the motor must be designed to operate with the pumped fluid inside it at all times. Such motors typically include special features such as hydrodynamic bearings for the rotor shaft and corrosion-resistant liners for the rotor bars and stator windings. Another disadvantage of such canned motor pumps is that they do not dissipate heat very efficiently because they do not have an external fan.

Another sealless pump-motor design is commonly referred to as a magnetically coupled pump, because the motor shaft and the pump shaft are coupled magnetically. The motor shaft is connected to a drive magnet assembly, and the pump shaft is connected to a driven magnet assembly. The drive and driven magnet assemblies are magnetically coupled together, such that rotation of the drive magnet assembly creates rotation of the driven magnet assembly, even though they do not touch each other. A thin stationary canister is located in a gap between the drive and driven magnet assemblies and serves as a part of the primary fluid containment barrier. While the magnetically coupled pump design works well, it does not provide a secondary containment feature.

### SUMMARY

The example embodiments shown and described herein provide a beneficial, economical electric rotary motor design that has effective cooling when in combination with a magnetically coupled external fan assembly. The combination also includes a secondary containment feature when used with a typical magnetically coupled fluid handling device, such as a pump.

The beneficial design overcomes disadvantages in the prior art by providing effective cooling, while protecting the internal components of an electric rotary motor from the surrounding environment. One particularly advantageous use for such an example device is when the surrounding environment contains explosive vapors that could explode upon contact with the internal components of an electric motor. Another example where the new design would be advantageous is when the motor may be subjected to a wash-down by a stream of water that could damage internal components of the motor. In these instances, a typical external cooling fan that is attached to and driven by the unused end of the motor's shaft is not suitable, because the gap between the shaft and the motor's casing would not protect the internal components of the motor from the surrounding environment or the water.

The present disclosure provides a magnetically coupled fan assembly in combination with an electric rotary motor, wherein the rotary motor includes a housing, an inner chamber and a shaft with the shaft further comprising a primary driving end and a secondary end; and the fan assembly includes a drive hub assembly further comprising a plurality of magnets and being connected to the secondary end of the shaft, a driven hub assembly further comprising a plurality of magnets and a plurality of fan blades, and a canister sealingly connected to the motor housing and having a portion positioned in a gap between the magnets of the drive hub assembly and the magnets of the driven hub assembly, and wherein the canister separates the drive hub assembly and the motor inner chamber from the fan blades and, rotation of the shaft causes rotation of the fan blades.

It is to be understood that both the foregoing general description and the following detailed description are exemplary and provided for the purposes of explanation only, and are not restrictive of the subject matter claimed. Further features and objects of the present disclosure will become more fully apparent in the following description of the preferred embodiments and from the appended claims.

### BRIEF DESCRIPTION OF THE DRAWINGS

In describing the preferred embodiments, references are made to the accompanying drawing figures wherein like parts have like reference numerals, and wherein:

FIG. 1 shows a partially sectioned side view of a first example magnetically coupled fan assembly in combination with an electric rotary motor.

FIG. 2 shows a perspective, partially exploded view of the first example shown in FIG. 1.

FIG. 3 shows a perspective exploded view of a drive hub assembly of the first example shown in FIGS. 1 and 2.

FIG. 4 shows a perspective exploded view of a driven hub assembly of the first example shown in FIGS. 1 and 2.

FIG. 5 shows a perspective view of a second example magnetically coupled fan assembly in combination with an electric rotary motor, with the rotary electric motor driving a magnetically coupled pump.

FIG. 6 shows a partially sectioned side view of the second example shown in FIG. 5.

FIG. 7 shows a perspective, partially exploded, partially sectioned view of the second example shown in FIGS. 5 and 6.

FIG. 8 shows a perspective exploded view of the drive hub assembly of the second example shown in FIGS. 6 and 7.

FIG. 9 shows a perspective exploded view of the driven hub assembly of the second example shown in FIGS. 6 and 7.

FIG. 10 shows a partially sectioned rear view of the second example shown in FIG. 5.

FIG. 11 shows a partially sectioned side view of a third example magnetically coupled fan assembly in combination with an electric rotary motor.

FIG. 12 shows a perspective, partially exploded view of the third example shown in FIG. 11.

FIG. 13 shows a perspective exploded view of the drive hub assembly of the third example shown in FIGS. 11 and 12.

FIG. 14 shows a perspective exploded view of the driven hub assembly of the third example shown in FIGS. 11 and 12.

It should be understood that the drawings are not to scale. While some mechanical details of the example magnetic couplings, fan assemblies, electric rotary motors and pumps, including details of fastening means and other plan and section views of the particular components, have not been shown, such details are considered to be within the comprehension of those skilled in the art in light of the present disclosure. It also should be understood that the present disclosure and claims are not limited to the preferred embodiments illustrated.

### DETAILED DESCRIPTION

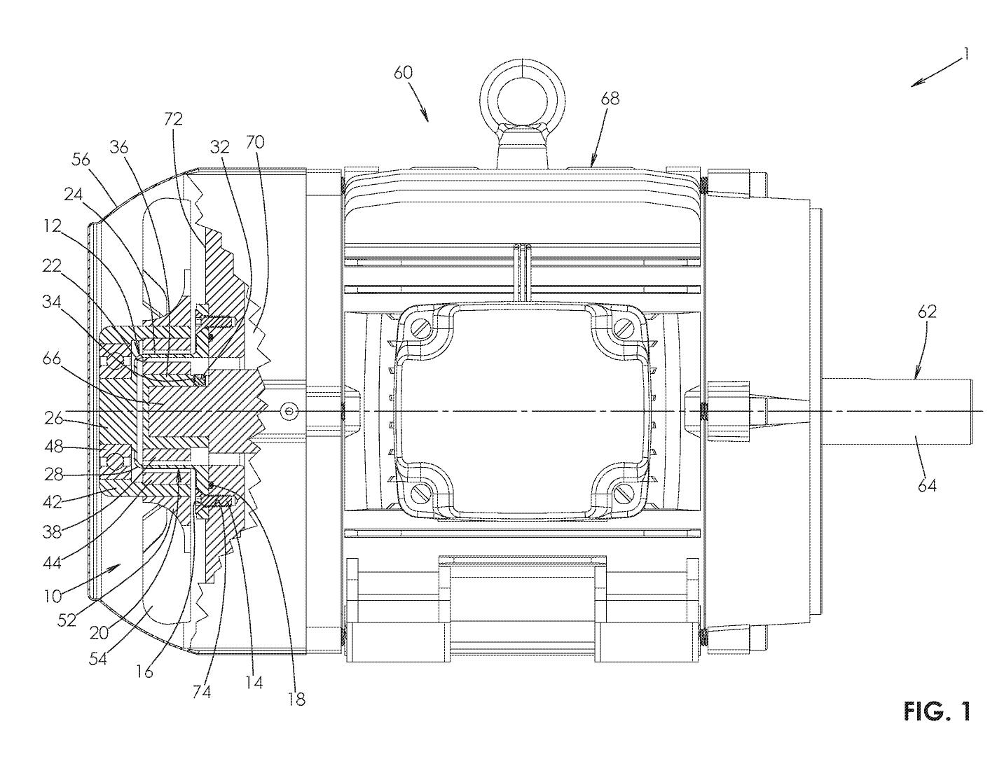

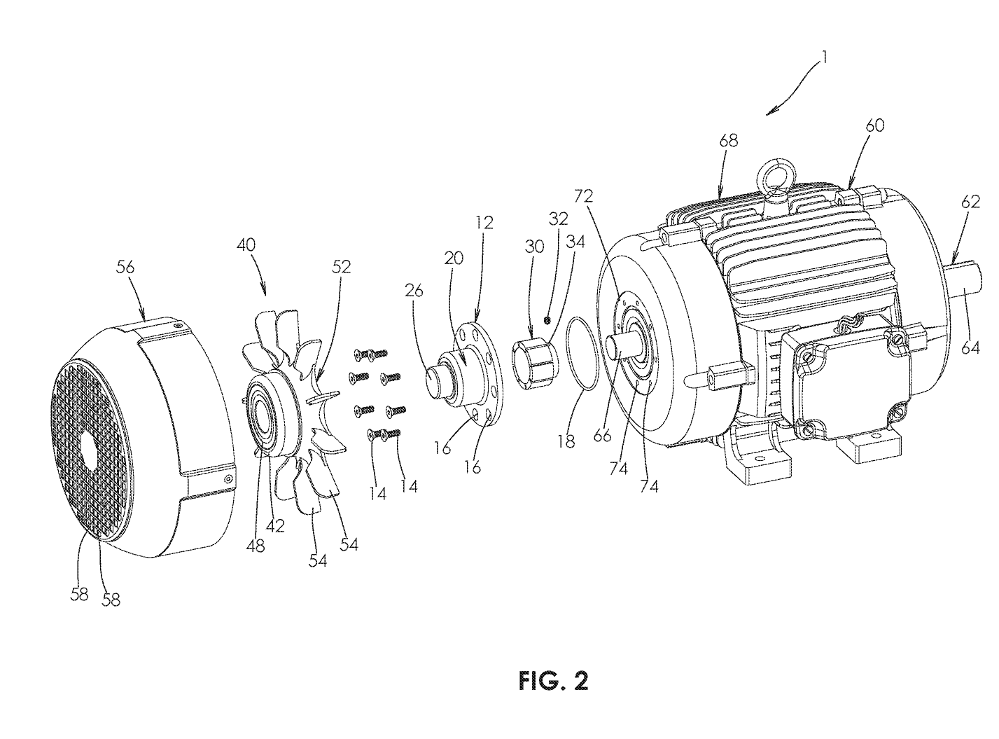

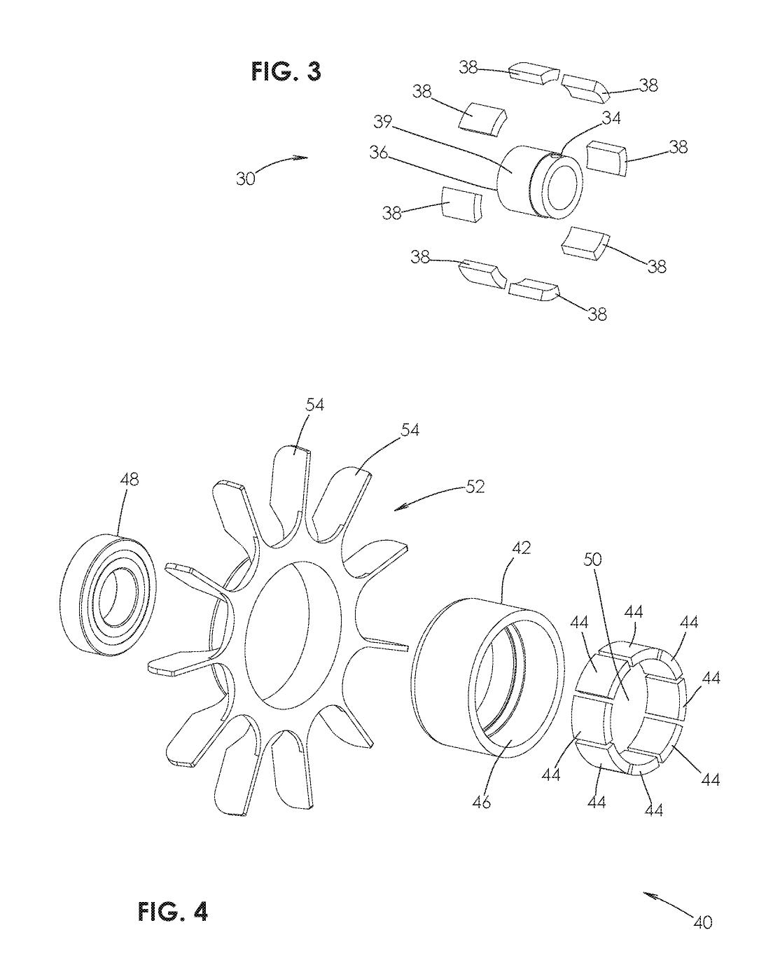

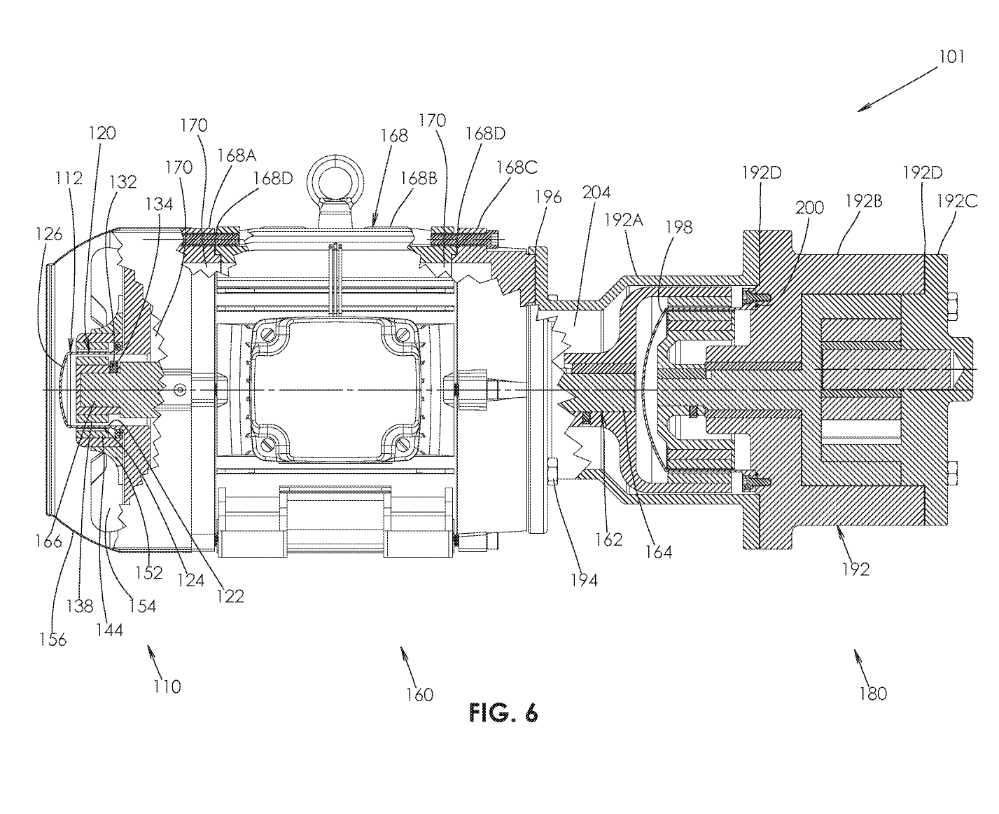

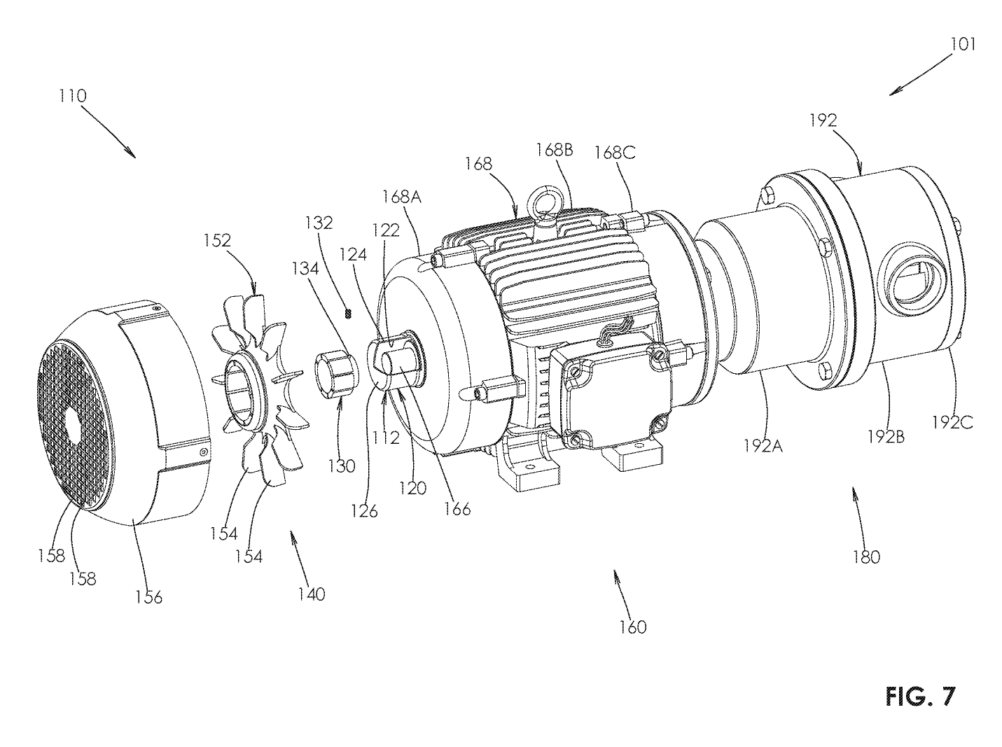

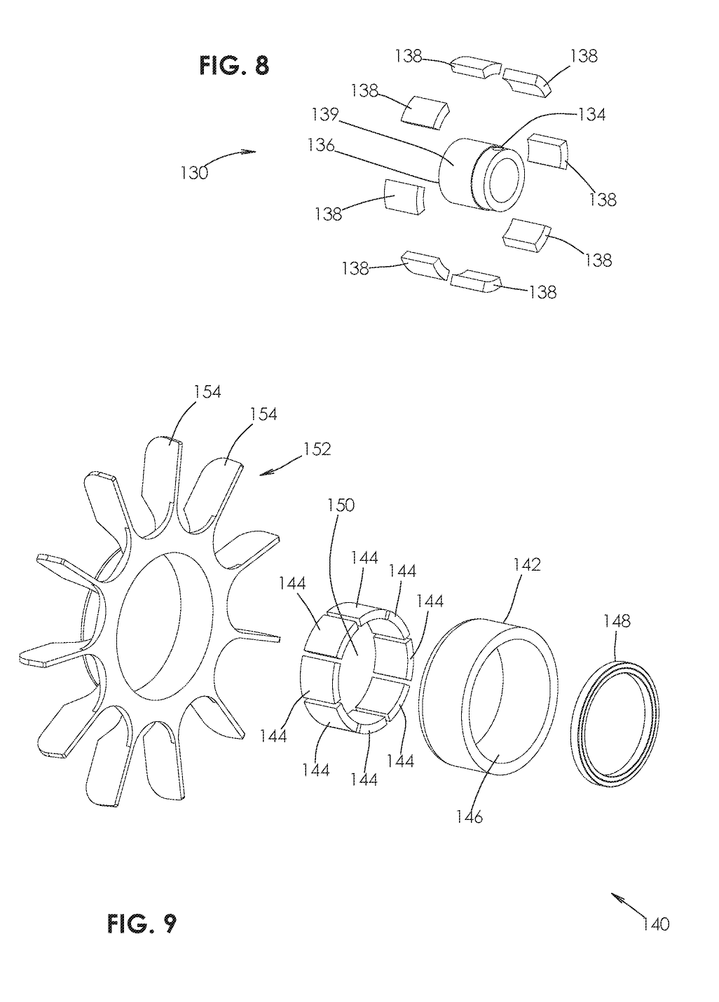

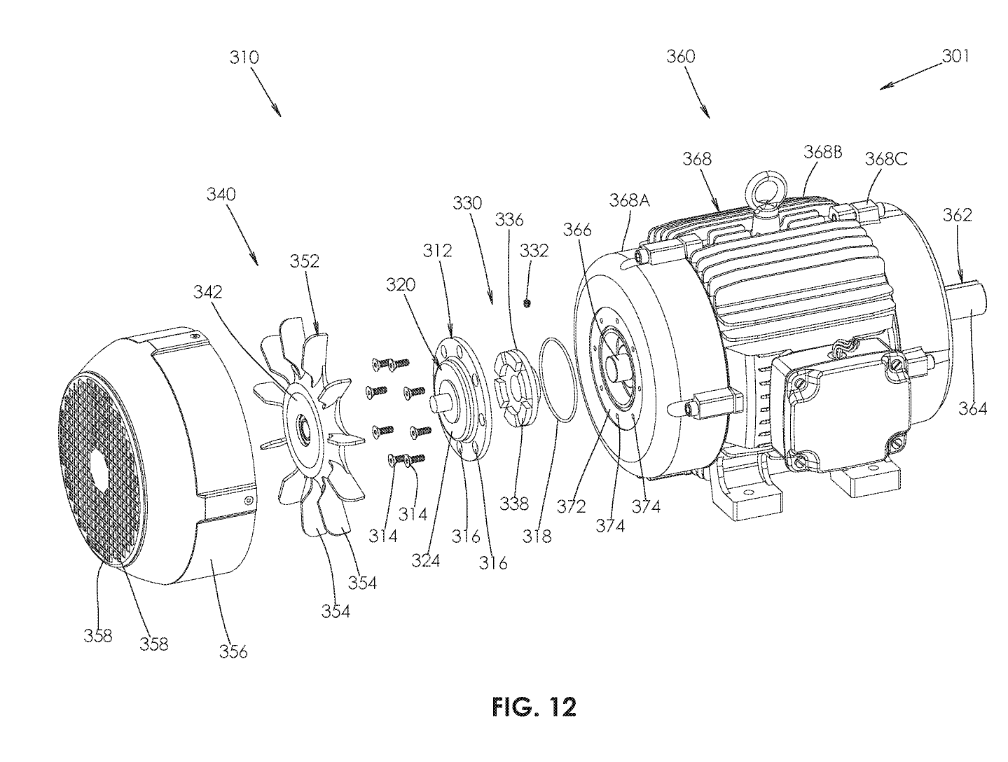

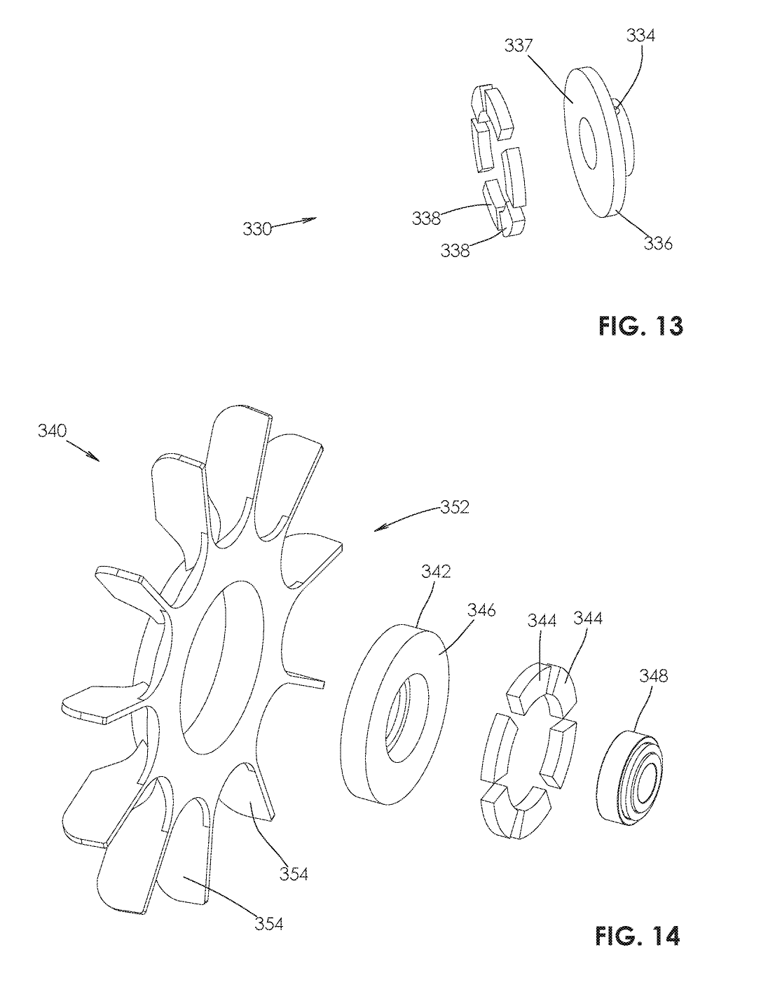

Referring generally to FIGS. 1-14, it will be appreciated that a magnetically coupled fan assembly in combination with an electric rotary motor of the present disclosure generally may be embodied within numerous configurations. For instance, as illustrated herein, the magnetic coupling may be of a radial drive or axial drive arrangement, the bearing for the driven hub assembly may be of different design or in a different location and the canister may or may not be integral with the housing of the motor.

Referring to a first example embodiment, in FIGS. 1-4, an example combination 1 includes a magnetically coupled fan assembly 10 connected to an example electric rotary motor 60. Motor 60 includes a rotatable shaft 62 that includes a primary end 64 and a secondary end 66. The main purpose of motor 60 is to have primary end 64 drive an apparatus, such as a pump or machine, not shown, wherein the apparatus requires the power input of motor 60. Motor 60 further includes a housing 68 and an inner chamber 70, which contains the operative components of electric rotary motor 60.

Fan assembly 10 includes a generally cup-shaped stationary canister 12 that is rigidly connected to a rear surface 72 of housing 68, such as by using fasteners 14, shown in this example as threaded screws that pass thru openings 16 in canister 12 and engage threaded holes 74 in rear surface 72 of housing 68. A seal 18 is positioned between canister 12 and rear surface 72 to provide a seal between canister 12 and housing 68. Seal 18 is shown in this example as an O-ring, but it will be appreciated that an alternative type of a seal may be used, such as a liquid sealant, gasket or the like.

Canister 12 includes a portion 20 that is generally cylindrical and may be constructed of a rigid material, but preferably is constructed of a material of low electrical conductivity, such as thermoplastic, ceramic, silicon carbide or the like. Alternatively, portion 20 that is generally cylindrical may be constructed of certain metals with low electrical conductivity, such as 316 stainless steel, alloy C-22, alloy C-276, titanium or the like. Generally cylindrical portion 20 of canister 12 includes an inner surface 22 and an outer surface 24. Canister 12 further includes an end cap portion 26 that closes rear end 28 of canister 12.

Fan assembly 10 further includes a drive hub assembly 30 that is connected to and rotates with secondary end 66 of motor shaft 62. Drive hub assembly 30 includes a drive ring 36 that may be constructed of rigid materials, and preferably is constructed of a material of high magnetic permeability, such as iron, carbon steel or the like. Drive hub assembly 30 is connected to shaft 62 via a setscrew 32 that is installed into a threaded opening 34 of drive ring 36 and tightened against secondary end 66 of shaft 62. It will be appreciated by one of ordinary skill in the art that other connection methods may be used, such as an interference fit, key in a keyway, adhesive or the like.

Drive hub assembly 30 further includes a plurality of magnets 38, which in this example is shown as eight magnets 38 that are connected to an outer surface 39 on drive ring 36. The plurality of magnets 38 of drive hub assembly 30 are radially charged and positioned with alternating polarity. Magnets 38 are rigidly connected to outer surface 39 of drive ring 36 using an adhesive, although alternative suitable means of connection may be used, such as use of fasteners or the like. Drive hub assembly 30 is sized such that it fits inside of inner surface 22 of generally cylindrical portion 20 of canister 12, without contacting inner surface 22.

Fan assembly 10 further includes a driven hub assembly 40 that includes a driven ring 42 that may be constructed of rigid materials, and preferably is constructed of a material of high magnetic permeability, such as iron, carbon steel or the like. Driven hub assembly 40 further includes a plurality of magnets 44, which in this example is shown as eight magnets 44 that are connected to an inner surface 46 on driven ring 42. The plurality of magnets 44 of driven hub assembly 40 are radially charged and positioned with alternating polarity. Magnets 44 are rigidly connected to inner surface 46 of driven ring 42 using an adhesive, although alternative suitable means of connection may be used, such as use of fasteners or the like.

Driven hub assembly 40 further includes a bearing 48 that fits on or otherwise is connected to end cap portion 26 of canister 12 to provide rotatable support for driven hub assembly 40. Driven ring 42 and magnets 44 are sized such that there is a central cavity 50 that is large enough to fit over outer surface 24 of generally cylindrical portion 20 of canister 12, without contacting outer surface 24. Drive hub assembly 30 and driven hub assembly 40 are sized such that magnets 38 of drive hub assembly 30 and magnets 44 of driven hub assembly 40 are in axial alignment. Generally cylindrical portion 20 of canister 12 is positioned in a gap between magnets 38 of drive hub assembly 30 and magnets 44 of driven hub assembly 40. Magnets 38 and magnets 44 create a magnetic field that imparts a driving torque upon driven hub assembly 40 when drive hub assembly 30 is rotated. The magnetic field also keeps driven hub assembly 40 axially aligned with drive hub assembly 30.

It will be appreciated that one may construct an embodiment with a different quantity of magnets 38 on drive hub assembly 30 and magnets 44 on driven hub assembly 40.

Driven hub assembly 40 further includes a fan 52 having a plurality of blades 54, which in this example is shown as ten blades 54, although it will be appreciated that one may construct an embodiment with blades of a different quantity, pitch, size and/or shape. Fan 52 is connected to driven ring 42 using an interference fit, although alternative suitable means of connection may be used, such as use of one or more fasteners, a key in a keyway, adhesive or the like. It will be appreciated that fan 52 is external to operative components of motor 60.

A generally cup-shaped fan cover 56 is connected to housing 68 of motor 60 and includes openings 58 that provide an intake for air. The driven hub assembly 40 rotates within the fan cover 56, which protects the blades 54 from damage and prevents inadvertent injury. Fan cover 56 is shaped or configured to have portions of its outer wall spaced apart from housing 68, such that fan cover 56 directs air that passes through openings 58 at the rear end to flow forward and over the outer surfaces of housing 68. Fan cover 56 may be connected to housing 68 by press fit engagement of particular features, or by use of fasteners, such as screws, set screws or the like.

When motor 60 is energized, shaft 62 rotates, which rotates drive hub assembly 30, which in turn imparts drive torque through the magnetic field to driven hub assembly 40, causing it to rotate. Rotation of fan blades 54 of driven hub assembly 40 causes air surrounding fan assembly 10, which normally will be ambient air, to flow over the outer surfaces of housing 68 of motor 60, thus providing a cooling effect.

Canister 12 and seal 18 create a stationary barrier that separates inner chamber 70 of motor 60 and drive hub assembly 30 from driven hub assembly 40 and fan blades 54 of fan 52.

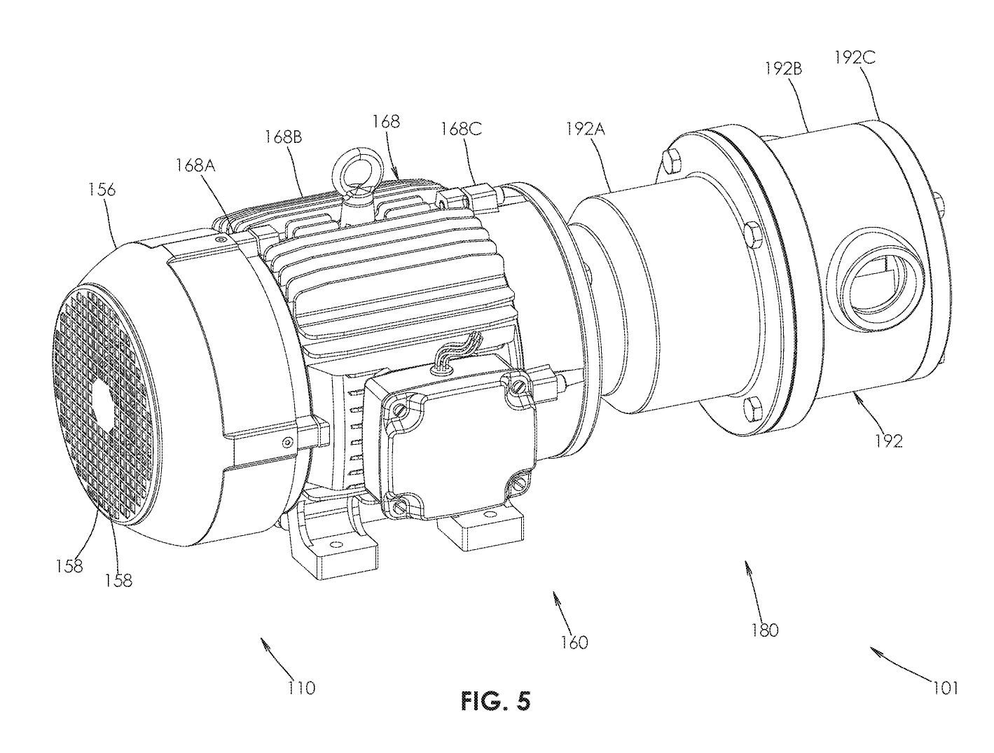

Referring to a second example embodiment, in FIGS. 5-10, a combination 101 includes a magnetically coupled fan assembly 110 connected to an electric rotary motor 160. Motor 160 includes a rotatable shaft 162 that includes a primary end 164 and a secondary end 166. The main purpose of motor 160 is to have primary end 164 drive an apparatus, which in this second example is a pump 180, such as a magnetically coupled pump, in the form of an internal gear pump. Secondary end 166 of shaft 162 is at the rear of motor 160 that otherwise would be unused. Fan assembly 110 is shown connected to electric rotary motor 160 at secondary end 166. Motor 160 further includes a housing 168 and an inner chamber 170. Housing 168 comprises a rear section 168A, a middle section 168B and a front section 168C that are connected together. Seals 168D are positioned between respective adjacent housing sections 168A, 168B and 168C to provide a seal between sections. Seals 168D are in the form of gaskets, although alternative suitable means of sealing may be used, such as O-rings, liquid sealants or the like.

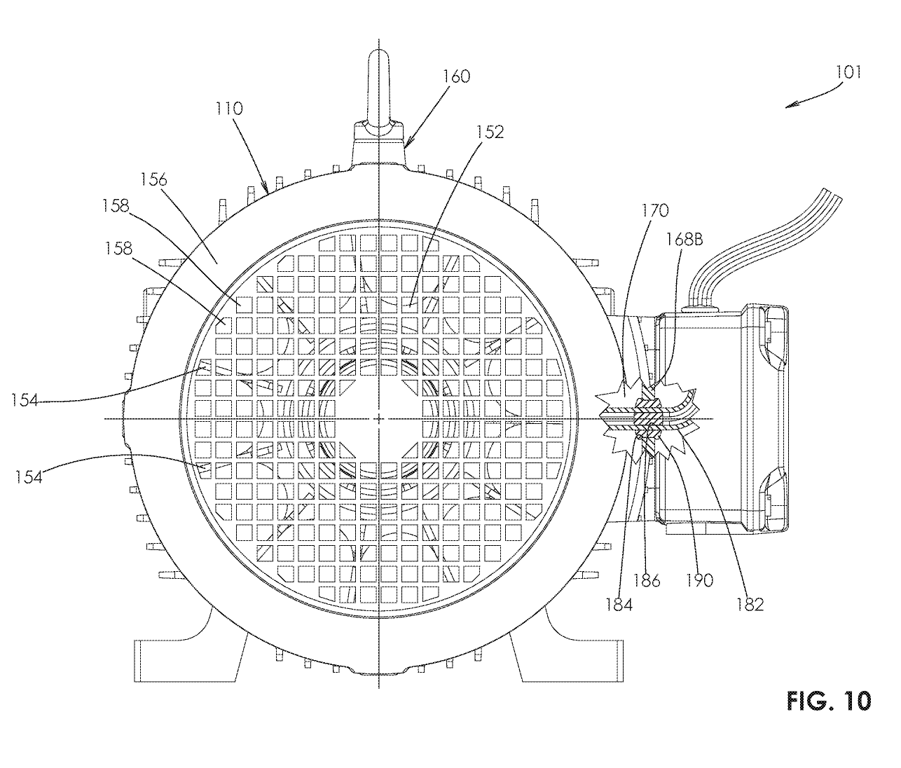

Referring to FIG. 10, motor 160 also includes electrical wires 182 that pass through an opening 184 in housing middle section 168B. Wires 182 pass through openings 186 in a seal 190, which is shown in the form of an elastomeric grommet that is positioned in opening 184. Grommet 190 provides a seal between wires 182 and housing middle section 168B, although alternative suitable means of sealing may be used, such as use of O-rings, liquid sealants or the like.

Referring back to FIGS. 5-9, magnetically coupled pump 180 includes a casing 192 having a rear section 192A, a central section 192B and a front section 192C that are connected together. Seals 192D are positioned between respective adjacent pump casing sections to provide a seal between sections. Seals 192D are in the form of gaskets, although alternative suitable means of sealing may be used, such as use of O-rings, liquid sealants or the like.

Rear section 192A of pump casing 192 is connected to front section 168C of housing 168 of motor 160, such as by using threaded fasteners 194 that pass thru openings (not shown) in rear section 192A and engage threaded holes (not shown) in front section 168C of housing 168. A seal 196 is positioned between rear section 192A of pump casing 192 and front section 168C of housing 168. Seal 196 is in the form of a gasket that provides a seal between pump casing 192 of pump 180 and housing 168 of motor 160. It will be appreciated that one may construct an embodiment with a different type of seal, such as an O-ring, liquid sealant or the like.

Pump 180 further includes a canister 198 that is connected to center section 192B of pump casing 192. A seal 200 is positioned between canister 198 and center section 192B. Seal 200 is in the form of an O-ring that provides a seal between canister 198 and center section 19B8 of pump casing 192. It will be appreciated that one may construct an embodiment with a different type of seal, such as a gasket, liquid sealant or the like.

Fan assembly 110 includes a stationary canister 112 that is generally cup-shaped, and in this example canister 112 is integrally formed with the motor housing 168, as part of rear section 168A. Canister 112 includes a portion 120 that is generally cylindrical and that may be constructed of rigid materials, and preferably is constructed of a material of low electrical conductivity, such as thermoplastic, ceramic, silicon carbide or the like. Alternatively, portion 120 that is generally cylindrical may be constructed of certain metals with low electrical conductivity, such as 316 stainless steel, alloy C-22, alloy C-276, titanium or the like. Portion 120 of canister 112 includes an inner surface 122 and an outer surface 124. Canister 112 further includes an end cap portion 126 that closes the rear end of canister 112.

Fan assembly 110 further comprises a drive hub assembly 130 that is connected to and rotates with secondary end 166 of shaft 162 of motor 160. Drive hub assembly 130 includes a drive ring 136 that may be constructed of rigid materials, and preferably is constructed of a material of high magnetic permeability, such as iron, carbon steel or the like. Drive hub assembly 130 is connected to shaft 162 via a setscrew 132 that is installed into a threaded opening 134 of drive ring 136 and is tightened against the secondary end 166 of shaft 162. It will be appreciated by one of ordinary skill in the art that other connection methods may be used, such as interference fit, keys, adhesives or the like.

Drive hub assembly 130 further includes a plurality of magnets 138, which in this second example is shown as eight magnets that are connected to an outer surface 139 on drive ring 136. The plurality of magnets 138 of drive hub assembly 130 are radially charged and positioned with alternating polarity. Magnets 138 are rigidly connected to outer surface 139 of drive ring 136 using an adhesive, although alternative suitable means of connection may be used, such as use of fasteners or the like. Drive hub assembly 130 is sized such that it fits inside of inner surface 122 of generally cylindrical canister portion 120 of canister 112, without contacting inner surface 122.

Fan assembly 110 further includes a driven hub assembly 140 that includes a driven ring 142 that may be constructed of rigid materials, and preferably is constructed of a material of high magnetic permeability, such as iron, carbon steel or the like. Driven hub assembly 40 further includes a plurality of magnets 144, which in this second example is shown as eight magnets 144 that are connected to an inner surface 146 on driven ring 142. The plurality of magnets 144 of driven hub assembly 140 are radially charged and positioned with alternating polarity. Magnets 144 are rigidly connected to inner surface 146 of driven ring 142 using an adhesive, although alternative suitable means of connection may be used, such as use of fasteners or the like.

Driven hub assembly 140 further includes a bearing 148 that fits on or otherwise is connected to canister 112 to provide rotatable support for driven hub assembly 140. Driven ring 142 and magnets 144 are sized such that there is a central cavity 150 that is large enough to fit over outer surface 124 of generally cylindrical portion 120 of canister 112, without contacting outer surface 124. Drive hub assembly 130 and driven hub assembly 140 are sized such that magnets 138 of drive hub assembly 130 and magnets 144 of driven hub assembly 140 are in axial alignment. Generally cylindrical portion 120 of canister 112 is positioned in a gap between magnets 138 of drive hub assembly 130 and magnets 144 of driven hub assembly 140. Magnets 138 and magnets 144 create a magnetic field that imparts a driving torque upon driven hub assembly 140 when drive hub assembly 130 is rotated. The magnetic field also keeps driven hub assembly 140 axially aligned with drive hub assembly 130.

It will be appreciated that one may construct an embodiment with a different quantity of magnets 138 on drive hub assembly 130 and magnets 144 on driven hub assembly 140.

Driven hub assembly 140 further comprises a fan 152 having a plurality of blades 154, which in this second example is shown as ten blades 154, although it will be appreciated that one may construct an embodiment with blades of a different quantity, pitch, size and/or shape. Fan 152 is connected to driven ring 142 using an interference fit, although alternative suitable means of connection may be used, such as use of one or more fasteners, a key in a keyway, adhesive or the like. It will be appreciated that fan 152 is external to operative components of motor 160.

A generally cup-shaped fan cover 156 is connected to housing 168 of motor 160 and includes openings 158 that provide an intake for air. Similar to fan cover 56 of the first example, fan cover 156 is shaped or configured to have portions of its outer wall spaced apart from housing 168, such that fan 156 directs air that passes through openings 158 at the rear end to flow forward and over the outer surfaces of housing 168. Fan cover 156 may be connected to housing 168 by press fit engagement of particular features, or by use of fasteners, such as screws, set screws or the like.

When motor 160 is energized, shaft 162 rotates, which rotates drive hub assembly 130, which in turn imparts drive torque through the magnetic field to driven hub assembly 140, causing it to rotate. Rotation of fan blades 154 of driven hub assembly 140 causes air surrounding fan assembly 110, which normally will be ambient air, to flow over the outer surfaces of housing 168 of motor 160, thus providing a cooling effect.

Canister 112 creates a stationary barrier that separates inner chamber 170 of motor 160 and drive hub assembly 130 from driven hub assembly 140 and fan blades 154 of fan 152.

During normal operation of pump 180, the pumped fluid is contained within a pumping chamber 202 bounded by front section 192C, center section 192B and canister 198 of pump 180. In the event of a failure of canister 198, the pumped fluid can escape pumping chamber 202, but is contained within a secondary containment chamber 204, bounded by canister 198 and casing rear section 192A of pump 180, and housing front section 168C, housing center section 168B, and housing rear section 168A of housing 168 of motor 160, along with canister 112 of fan assembly 110.

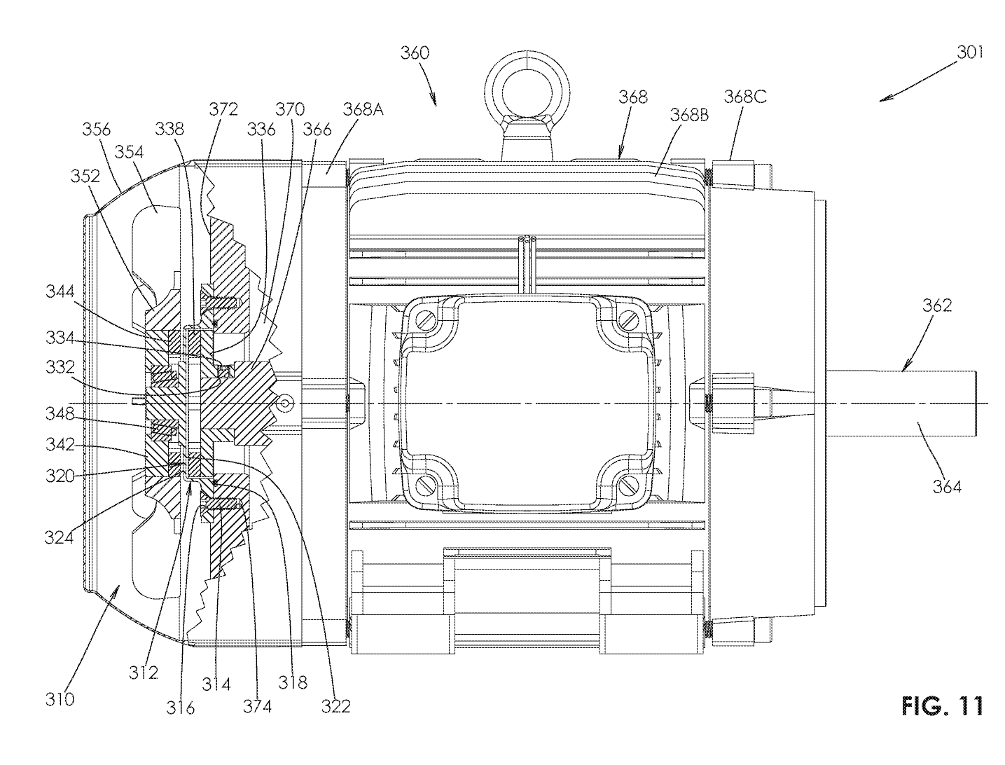

Referring now to a third example embodiment, in FIGS. 11-14, a combination 301 includes a magnetically coupled fan assembly 310 connected to an electric rotary motor 360. Motor 360 includes a rotatable shaft 362 that includes a primary end 364 and a secondary end 366. The main purpose of motor 360 is to have primary end 364 drive an apparatus, such as a pump or machine (not shown), wherein the apparatus requires the power input of motor 360. Motor 360 further includes a housing 368 and an inner chamber 370, which contains the operative components of electric rotary motor 360.

Fan assembly 310 includes a stationary canister 312 that is rigidly connected to a rear surface 372 of housing 368, such as by using fasteners 314, shown in this third example as threaded screws that pass thru openings 316 in canister 312 and engage threaded holes 374 in rear surface 372 of housing 368. A seal 318 is positioned between canister 312 and rear surface 372 to provide a seal between canister 312 and housing 368. Seal 318 is shown in this third example as an O-ring, but it will be appreciated that an alternative type of seal may be used, such as a liquid sealant, gasket or the like.

Canister 312 includes a portion 320 that is generally flat and may be constructed of a rigid material, and preferably is constructed of a material of low electrical conductivity, such as thermoplastic, ceramic, silicon carbide or the like. Alternatively, portion 320 that is generally flat may be constructed of certain metals with low electrical conductivity, such as 316 stainless steel, alloy C-22, alloy C-276, titanium or the like. Generally flat portion 320 of canister 312 includes a front surface 322 and a rear surface 324.

Fan assembly 310 further includes a drive hub assembly 330 that is connected to and rotates with the secondary end 366 of motor shaft 362. Drive hub assembly 330 includes a drive ring 336 that may be constructed of rigid materials, and preferably is constructed of a material of high magnetic permeability, such as iron, carbon steel or the like. Drive hub assembly 330 is connected to shaft 362 via a setscrew 332 that is installed into a threaded opening 334 of drive ring 336 and tightened against secondary end 366 of shaft 362. It will be appreciated by one of ordinary skill in the art that other connection methods may be used, such as an interference fit, key in a keyway, adhesive or the like.

Drive hub assembly 330 further includes a plurality of magnets 338, which in this third example is shown as six magnets 338 that are connected to rear surface 337 on drive ring 336 using an adhesive, although alternative suitable means of connection may be used, such as use of fasteners or the like. The plurality of magnets 338 of drive hub assembly 330 are axially charged and positioned with alternating polarity. Drive hub assembly 330 is sized such that it fits in front of front surface 322 of generally flat portion 320 of canister 312, without contacting front surface 322.

Fan assembly 310 further includes a driven hub assembly 340 that includes a driven ring 342 that may be constructed of rigid materials, and preferably is constructed of a material of high magnetic permeability, such as iron, carbon steel or the like. Driven hub assembly 340 further includes a plurality of magnets 344, which in this third example is shown as six magnets 344 that are connected to a front surface 346 on driven ring 342. The plurality of magnets 344 of driven hub assembly 340 are axially charged and positioned with alternating polarity. Magnets 344 are rigidly connected to the front surface 346 of driven ring 342 using an adhesive, although alternative suitable means of connection may be used, such as use of fasteners or the like.

Driven hub assembly 340 further includes a bearing 348 that fits on or otherwise is connected to generally flat portion 320 of canister 312 to provide rotatable support for driven hub assembly 340. Driven ring 342 and magnets 344 are sized such that they fit behind rear surface 324 of generally flat portion 320 of canister 312, without contacting rear surface 324. Drive hub assembly 330 and driven hub assembly 340 are sized such that magnets 338 of drive hub assembly 330 and magnets 344 of driven hub assembly 340 are in radial alignment. Generally flat portion 320 of canister 312 is positioned in a gap between magnets 338 of drive hub assembly 330 and magnets 344 of driven hub assembly 340. Magnets 338 and magnets 344 create a magnetic field that imparts a driving torque upon driven hub assembly 340 when drive hub assembly 330 is rotated. The magnetic field also keeps driven hub assembly 340 axially aligned with drive hub assembly 330.

It will be appreciated that one may construct an embodiment with a different quantity of magnets 338 on drive hub assembly 330 and magnets 344 on driven hub assembly 340.

Driven hub assembly 340 further includes a fan 352 having a plurality of blades 354, which in this third example is shown as ten blades 354, although it will be appreciated that one may construct an embodiment with blades of a different quantity, pitch, size and/or shape. Fan 352 is connected to driven ring 342 using an interference fit, although alternative suitable means of connection may be used, such as use of one or more fasteners, a key in a keyway, adhesive or the like. It will be appreciated that fan 352 is external to operative components of motor 360.

A generally cup-shaped fan cover 356 is connected to housing 368 of motor 360 and includes openings 358 that provide an intake for air. Fan cover 356 is shaped or configured to have portion of its outer wall spaced apart from housing 368, such that fan cover 356 directs air that passes through openings 358 at the rear end to flow forward and over the outer surfaces of housing 368. As with the previous examples, fan cover 356 may be connected to housing 368 by press fit engagement of particular features, or by use of fasteners, such as screws, set screws or the like.

When motor 360 is energized, shaft 362 rotates, which rotates drive hub assembly 330, which in turn imparts drive torque through the magnetic field to driven hub assembly 340, causing it to rotate. Rotation of fan blades 354 of driven hub assembly 340 causes air surrounding fan assembly 310, which normally will be ambient air, to flow over the outer surfaces of housing 368 of motor 360, thus providing a cooling effect.

Canister 312 and seal 318 create a stationary barrier that separates inner chamber 370 of motor 360 and drive hub assembly 330 from driven hub assembly 340 and fan blades 354 of fan 352.

From the above disclosure, it will be apparent that a magnetically coupled fan assembly in combination with an electric rotary motor constructed in accordance with this disclosure may include a number of structural aspects that provide advantages over prior art cooling systems for electric rotary motors, depending upon the specific design chosen.

It will be appreciated that a magnetically coupled fan assembly in combination with an electric rotary motor may be embodied in various configurations. Any variety of suitable materials of construction, configurations, shapes and sizes for the components and methods of connecting the components may be utilized to meet the particular needs and requirements of an end user. It will be apparent to those skilled in the art that various modifications can be made in the design and construction of such a magnetically coupled fan assembly in combination with an electric rotary motor without departing from the scope or spirit of the claimed subject matter, and that the claims are not limited to the preferred embodiment illustrated herein.

1. A magnetically coupled fan assembly in combination with an electric rotary motor, comprising: the rotary motor includes a housing, an inner chamber and a shaft with the shaft further comprising a primary driving end and a secondary end; and the fan assembly includes a drive hub assembly further comprising a plurality of magnets and being connected to the secondary end of the shaft, a driven hub assembly further comprising a plurality of magnets and a plurality of fan blades, and a canister sealingly connected to the motor housing and having a portion positioned in a gap between the magnets of the drive hub assembly and the magnets of the driven hub assembly, and wherein the canister separates the drive hub assembly and the motor inner chamber from the fan blades, and rotation of the shaft causes rotation of the fan blades.

2. A magnetically coupled fan assembly in combination with an electric rotary motor of claim 1 wherein the magnets of the drive hub assembly are on an outer surface, the magnets of the driven hub assembly are on an inner surface and are positioned outside the magnets on the drive hub assembly, and the portion of the canister that is positioned in the gap between the magnets of the drive hub assembly and the magnets of the driven hub assembly is generally cylindrical.

3. A magnetically coupled fan assembly in combination with an electric rotary motor of claim 2 wherein the drive hub assembly further comprises a drive ring and the magnets of the drive hub assembly are connected to an outer surface of the drive ring.

4. A magnetically coupled fan assembly in combination with an electric rotary motor of claim 2 wherein the driven hub assembly further comprises a driven ring and the magnets of the driven hub assembly are connected to an inner surface of the driven ring.

5. A magnetically coupled fan assembly in combination with an electric rotary motor of claim 1 wherein the magnets of the drive hub assembly are on a rearward facing surface, the magnets of the driven hub assembly are on a forward facing surface and are positioned behind the magnets of the drive hub assembly, and the portion of the canister that is positioned in the gap between the magnets of the drive hub assembly and the magnets of the driven hub assembly is generally flat.

6. A magnetically coupled fan assembly in combination with an electric rotary motor of claim 5 wherein the drive hub assembly further comprises a drive ring and the magnets of the drive hub assembly are connected to a rearward facing surface of the drive ring.

7. A magnetically coupled fan assembly in combination with an electric rotary motor of claim 5 wherein the driven hub assembly further comprises a driven ring and the magnets of the driven hub assembly are connected to a forward facing surface of the driven ring.

8. A magnetically coupled fan assembly in combination with an electric rotary motor of claim 1 wherein the driven hub assembly further comprises a bearing that supports the driven hub assembly and is connected to the canister or to the housing of the motor.

9. A magnetically coupled fan assembly in combination with an electric rotary motor of claim 8 wherein the canister further comprises an end cap portion and the bearing of the driven hub assembly is connected to the end cap portion of the canister.

10. A magnetically coupled fan assembly in combination with an electric rotary motor of claim 1 wherein the portion of the canister that is positioned in the gap between the magnets of the drive hub assembly and the magnets of the driven hub assembly is constructed of a material with zero or low electrical conductivity.

11. A magnetically coupled fan assembly in combination with an electric rotary motor of claim 1 wherein the canister is integrally formed as part of the housing of the motor.

12. A magnetically coupled fan assembly in combination with an electric rotary motor of claim 1 wherein the fan assembly further comprises a fan cover and the driven hub assembly rotates within the fan cover.

13. A magnetically coupled fan assembly in combination with an electric rotary motor of claim 12 wherein the fan cover is connected to the housing of the motor.

14. A magnetically coupled fan assembly in combination with an electric rotary motor of claim 1 wherein the housing of the motor further comprises a plurality of sections that are sealingly connected to each other and a plurality of electric wires that pass through an opening in the housing of the motor, wherein a seal is disposed between the plurality of wires and the opening in the housing of the motor.

15. A magnetically coupled fan assembly in combination with an electric rotary motor of claim 1 wherein the primary driving end of the motor shaft drives a magnetically coupled pump.

16. A magnetically coupled fan assembly in combination with an electric rotary motor of claim 15 wherein the magnetically coupled pump includes a stationary canister.

17. A magnetically coupled fan assembly in combination with an electric rotary motor of claim 15 wherein the magnetically coupled pump includes a casing that is sealingly connected to the housing of the motor.
